(19) United States
(12) Patent Application Publication
(10) Pub. No.: US 2003/0218890 A1
(43) Pub. Date: Nov. 27, 2003

(54) AC power line filter for audio and vldeo applications

(75) Inventor: David Leroy Kerstetter, Thousand Oaks, CA (US)

Correspondence Address: David Kerstetter, P.O. Box 551, Agoura Hills, CA, 91376, US

(73) Assignee: David L. Kerstetter

(21) Appl. No.: 10/155,161

(22) Filed: May 24, 2002

(51) Int. Cl. H02M 1/12

(52) U.S. Cl. 363/44

(57) ABSTRACT

A filter circuit for removing noise and harmonic frequencies from alternating current power sources. The result of which will improve the performance of audio or video devices powered by said power source. The filter does not limit power flow to the load device. The basis of the filter is an inductor and capacitor tuned to the fundamental frequency of the power line.

### CROSS-REFERENCE TO RELATED APPLICATIONS

Not Applicable

### STATEMENT REGARDING FEDERALLY SPONSORED RESEARCH OR DEVELOPMENT

None

### BACKGROUND OF THE INVENTION

This invention is for the improvement of the functioning of alternating current powered Audio & Video devices. This is accomplished by improving the quality of the power at the device(s) connected to the filter or in close proximity on the same electrical circuit.

| | |
|---|---|
| 6,198,643 | March 2001 |
| 5,920,469 | July 1999 |
| 5,343,381 | August 1994 |
| 5,260,862 | November 1993 |
| 4,939,486 | July 1990 |
| 4,760,356 | July 1988 |
| 4,551,780 | November 1985 |
| 2,743,412 | April 1956 |
| 1,255,387 | February 1918 |

There have been various previous approaches to filtering alternating current power sources. Most limiting the power available from the source in certain frequency ranges.

Several types of filters are:

Low pass filters in series with the power line. These limit the power flow to the load.

Filters having only capacitors or only inductors. These provide filtering or energy storage but themselves constantly draw power making them wasteful of energy. The inductor only approach stores energy but does not filter out unwanted frequencies on the power line.

Other approaches use ferrite beads, isolation transformers, or common mode chokes. These all limit power flow to the load.

Previous inductor/capacitor resonant circuits have other parts to isolate, limit, protect, or stabilize voltages or frequencies of circuits. Some are setup to filter only certain harmonic frequencies of the power source.

### BRIEF SUMMARY OF THE INVENTION

The invention is for the purpose of providing clean alternating current power to a load. The field of application is in improving the performance of audio & video equipment.

### OBJECTS AND ADVANTAGES OF THE NEW INVENTION

The filter improves the audio quality of a sound reproduction or recording system.

The filter improves the video quality of a video reproduction or recording system.

The filter offers improvements by removing unwanted frequency components from the power source while not limiting what power can be drawn.

The filter is also an energy storage circuit improving the purity of the fundamental power line frequency.

The filter does not draw power from the power line except for losses due to no electrical components being perfect inductors or capacitors. The inductor and capacitor in the circuit are selected to be resonant at the power source frequency and therefore draw minimal power.

The capacitor that does the filtering of frequencies above the power source frequency is able to be much larger than is normally used because of the current canceling effect of the inductor. The larger capacitor is more able to remove unwanted signals present in the power source.

Multiple filter units may be used in parallel to increase the filtering effect.

The resonant action of the filter acts to smooth over sags or voltage spikes in the power source.

A power outlet may be added to the body of the filter unit to provide the cleanest power for a load device. Or it may be added in parallel to the power source to provide improvements for load devices on the same circuit.

### BRIEF DESCRIPTION OF THE SEVERAL VIEWS OF THE DRAWINGS

FIG. 1; The inductor(1)/capacitor (2) filter arrangement with a power source (3) and a load device (4). The filter is across the power source terminals removing signals above and below the fundamental frequency of the power source.

FIG. 2 shows a possible variation on FIG. 1. Multiple smaller capacitors (5,6,7) are used to add up to the same value as capacitor (2). This variation allows a broader effective range of filtering action while still resonant at the power source frequency. The smaller valued capacitors are more effective a high frequencies than one single large capacitor.

FIG. 3 shows a possible variation on FIG. 1. Multiple inductors (8,9) are used to add up to the same values inductor (1).

FIG. 4 shows adding a power outlet (10) to provide power directly to a load (4). The filter circuit as a whole is indicated as item 11.

FIG. 5 shows the filter circuit (11) in parallel with the power source (3) on a distribution circuit with multiple loads (4, 12)

FIGS. 6 and 7 show basic applications to three phase circuits. FIG. 6 is a delta circuit with filters (11) between each phase. FIG. 7 is for a wye circuit with filters (11) from each phase to a common.

### REFERENCE NUMERALS

1) inductor

2) capacitor

3) AC power source

4) load

5) capacitor

6) capacitor

7) capacitor

8) inductor

9) inductor

10) outlet for powering load

11) inductor/capacitor circuit as a whole

12) load

### DETAILED DESCRIPTION OF THE INVENTION

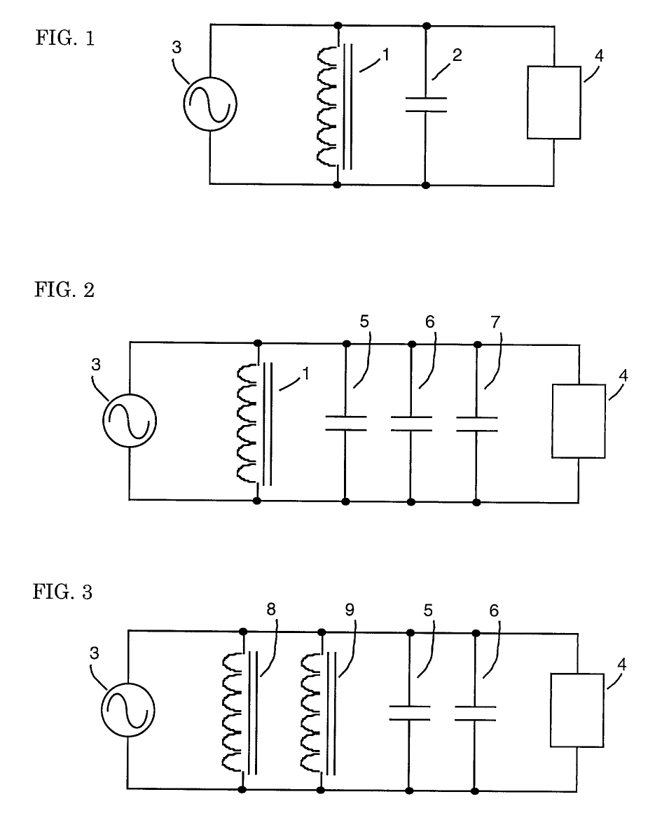

The filter as shown in FIG. 1 as an inductor (1) and capacitor (2) in parallel with a AC power source (3) powering a load (4). The inductor and capacitor are selected to be resonant at the power source frequency.

Frequencies other than the power source frequency are shunted through the filter instead of going to the load and interfering with its operation.

As shown in FIGS. 2 and 3 the capacitor (1) and inductor (2) of FIG. 1 may be made up of several smaller valued components.

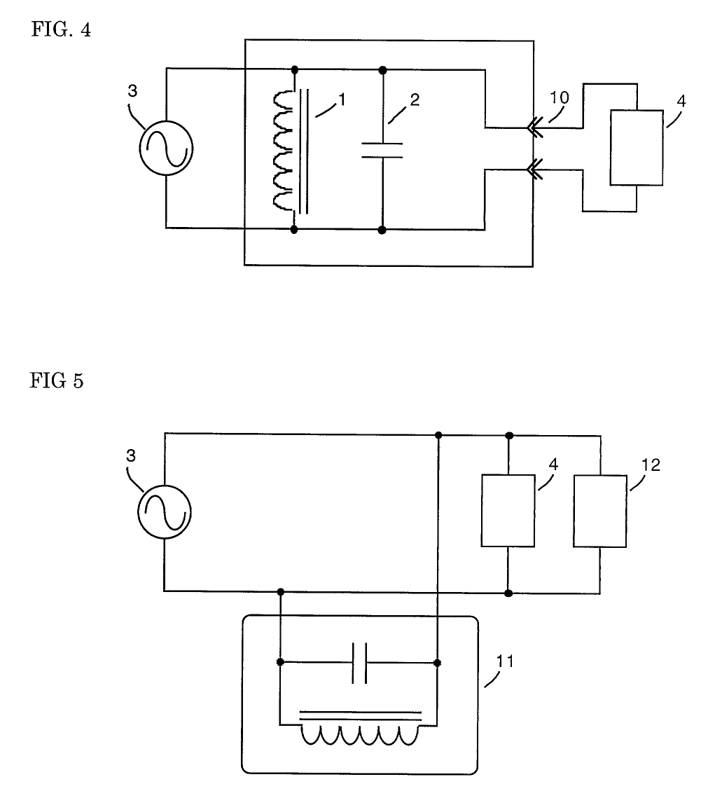

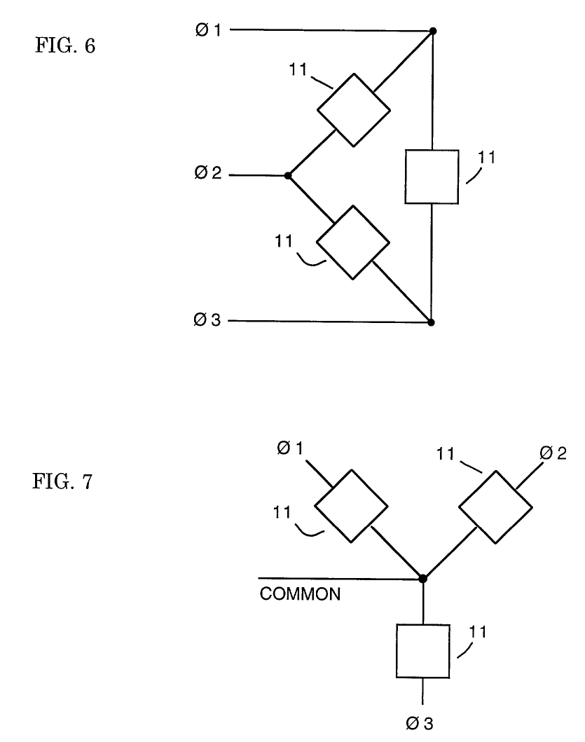

To provide the most filtered power an outlet may be added to the body of the filter device as in FIG. 4.

The size of the filter may be sized to fit the application or economics of the installation. The component values are chosen to match the frequency of the power source. The component values are also chosen to fit the power source voltage. Typical values for a 60 cycle filter are a 7 microfarad capacitor and a 1 henry inductor.

What I claim as my invention is:

1) A filter circuit for improving the quality of alternating current power supplied to audio or video equipment. Frequencies other than the fundamental frequency of the power source are attenuated. The filter circuit is;
An inductance in parallel with a capacitance tuned be resonant at the power source fundamental frequency to minimize power drawn from the source by the filter. The filter will work but less effectively and with increased power drawn if not tuned to the power frequency.
Said inductor and capacitor being in parallel with the power source. Being only in parallel with the power source no limit is placed on power drawn by the load.
Said filter may be constructed as a standalone device or as part of the power inlet of a electrical or electronic system or device.

2) A filter as claimed in claim 1 where the said capacitor is comprised of multiple smaller capacitors.

3) A filter as claimed in claim 1 where the said inductor is comprised of multiple smaller inductors.
